(19) United States
(12) Patent Application Publication
(10) Pub. No.: US 2008/0303440 A1
(43) Pub. Date: Dec. 11, 2008

(54) PLASMA DISPLAY PANEL

(76) Inventors: Yoshimi Kawanami, Miyazaki (JP); Nobuyuki Hori, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/038,087

(22) Filed: Feb. 27, 2008

(30) Foreign Application Priority Data
Jun. 6, 2007 (JP) 2007-149902

(51) Int. Cl. H01J 17/49

(52) U.S. Cl. 313/584

(57) ABSTRACT

A transmission-type PDP capable of dealing with a moiré pattern which occurs on a display surface of a panel is provided. This PDP comprises: a rear unit having a pair of lateral display electrodes; a front unit having a longitudinal address electrode and including a display surface; and a barrier rib having transmittance and a phosphor layer. An electric potential of the address electrode is held constant in a display period. In this manner, a layer of the longitudinally striped address electrodes (first shielding layer) achieves an effect of shielding electromagnetic wave. Further, a layer of a laterally-striped electrode pattern (second shielding layer) may be arranged on a front surface of the panel. Superposing the above two shielding layers prevents the occurrence of a moiré pattern.

### CROSS-REFERENCE TO RELATED APPLICATION

The present application claims priority from Japanese Patent Application No. JP 2007-149902 filed on Jun. 6, 2007, the content of which is hereby incorporated by reference into this application.

### TECHNICAL FIELD OF THE INVENTION

The Present invention relates to a plasma display panel (PDP) and a display device thereof (plasma display devices: PDP devices). More particularly, the present invention relates to a transmission-type PDP, a filter, and a countermeasure for electromagnetic wave.

### BACKGROUND OF THE INVENTION

For an AC (alternating current drive) type PDP device, as a way of using the light emission from phosphors by discharge, a transmission type has been considered in the early stages. However, since this type has been regarded to be insufficient in terms of the light emission efficiency, the structure of a current reflection type has become mainstream. Note that, here, the transmission type means a type whose front unit side having a display surface has an address electrode (denoted by A), a phosphor, and so forth arranged thereto, and whose rear unit side has a display electrode arranged thereto. The reflection type means the opposite of the transmission type. The display electrode is a sustain electrode (denoted by X), a scanning electrode (denoted by Y), and the like used for discharge (sustain discharge) in a display period.

However, also in recent years, some studies on the modification of the transmission-type PDP have been made. As for a three-electrode/transmission-type PDP, there are those disclosed in Japanese Patent Application Laid-Open Publication No. 2004-356063 and Japanese Patent Application Laid-Open Publication No. 2004-14372. As for a four-electrode/transmission-type PDP, there is the one disclosed in Japanese Patent No. 3437596.

Further, in a conventional PDP, the front side of the panel has an optical filter provided for various purposes. For example, the optical filter includes a glass filter, a directly-attached film filter, and the like. The function/characteristics of the filter generally include electromagnetic-wave shielding, suppression of outside light reflection, cutting near infrared ray, color adjustment, and the like according to the panel structure.

In the reflection type PDP which is conventional mainstream, electromagnetic waves are generated by alternative potential variations at a pair of display electrodes (X and Y) on the front side of the panel. For the countermeasure against the electromagnetic wave emitted from the panel main body (front side), ordinarily it has been necessary to provide a layer (electromagnetic-wave shielding layer) having a function of shielding electromagnetic wave as a part of layers in the above-said filters.

As an example of a conventional art of the filter and the like provided on the front side of the panel, in addition to the electromagnetic-wave shielding layer, a microlouver film (light shielding element for controlling light transmission and shielding) and the like are included. For example, Japanese Patent Application Laid-Open Publication No. 2006-313360 discloses a contrast improving film, which provides an outside-light shielding layer capable of preventing a moiré pattern.

### SUMMARY OF THE INVENTION

With respect to the conventional transmission-type PDP, there has been room for consideration/improvement in various points such as emission efficiency. Further, in the conventional mainstream reflection type PDP, as a countermeasure for the electromagnetic wave, normally it has been necessary to provide an electromagnetic-wave shielding layer on the panel front surface side or a filter including the electromagnetic-wave shielding layer, thereby leading to a higher cost. Such an electromagnetic-wave shielding layer includes a mesh type (referred to as mesh shielding layer and the like), a sputtered multilayer film (sputtered solid film), and the like.

Heretofore, for example, when the mesh shielding layer is used, as shown in FIG. 7 and FIG. 8, a moiré pattern occurs on the panel front surface (display surface) side due to a superposing of a cell pattern (lattice-shaped) with a mesh pattern. Corresponding to a shift and the like of straight lines (metal electrodes and the like) of both patterns with respect to each other, the moiré pattern occurs by cyclic interference. This invites the deterioration of a display quality. The arrangement and the fixation of the electromagnetic-wave shielding layer (filter and the like) on the panel main body require a labor hour to deal with the moiré pattern, thereby leading a higher cost. The labor hour is, for example, for the fine adjustment of an arrangement angle of the cell pattern and the mesh shielding layer by the worker upon manufacturing of a PDP or for design/manufacture of different meshed filters for every panel structure (difference in the cell patterns) so that both sides make a predetermined arrangement angle.

The present invention has been made in view of the above described problems, and an object of the invention is to provide a technique capable of reducing cost by providing an electromagnetic-wave shielding layer or a filter and the like on the panel front surface side for the electromagnetic countermeasure in the PDP technique, and in particular, capable of dealing with the occurrence of a moiré pattern on a panel display surface.

The typical ones of the inventions disclosed in this application will be briefly described as follows. To achieve the above-said object, the present invention has a configuration as described below based on the transmission-type PDP.

First, the present PDP (transmission-type PDP) comprising a first and a second substrate structures sandwiching a discharge space to encapsulate a discharge gas, in the present PDP, a display cell group is configured by an electrode group, thereby displaying a screen image on a region of the display cell group by drive control by a subfield method, the present PDP comprises: a display electrode pair (X, Y) covered by, for example, a first dielectric layer and extending in a first direction to a first glass substrate in the first substrate structure (rear unit); and an address electrode (A) covered by, for example, a second dielectric layer and extending in a second direction to a second glass substrate in the second substrate structure (front unit), in the present PDP, the first substrate structure is arranged on the rear side, and the second substrate structure is arranged on a front surface side. Note that, for purpose of description, in the present PDP, whose front unit is called a second substrate structure and whose rear unit is called a first substrate structure.

In addition, in the present PDP, the second substrate structure includes barrier ribs formed by extending at least in the second direction so as to divide the discharge space and phosphors (phosphor layers) of respective colors formed being exposed in the discharge space between the barrier ribs. The barrier ribs and phosphors are formed on, for example, the substrate of the front unit. Further, for example, optical transmittance to the emission (discharge emission) of the phosphor is given to the barrier ribs, so that improving the emission efficiency of the panel (transmission-type PDP).

(1) In the configuration of the transmission-type PDP described above, as a drive condition about the address electrode of the front side of the panel, the electric potential is held substantially constant during a display period (sustain period) of a subfield. Except for the address period in which an address pulse is applied, potential variations at the address electrode is eliminated.

In the above-described manner, the layer of the address electrode group in stripes along the second direction on the front unit side (taken as a first shielding layer) itself achieves a sufficiently large function (effect) of shielding electromagnetic wave. In other words, the occurrence of electromagnetic wave at the front unit side is suppressed, and the electromagnetic wave occurring at the display electrode pair on the rear side is also shielded by the layer of the address electrode. Consequently, providing the electromagnetic-wave shielding layer or the filter including the electromagnetic-wave shielding layer and the like as is conventionally done is not a requirement, thereby reducing cost by omitting the required parts. It does not matter if the effect of the electromagnetic wave shielding and the like is heightened by further providing the electromagnetic-wave shielding layer on the front side of the panel.

(2) In the configuration of the above (1), while even the layer of the address electrode group in stripes along the second direction (first shielding layer) alone can achieve the effect of electromagnetic-wave shielding, the following configuration is further provided. To the front side of the panel, means for electromagnetic-wave shielding or light shielding or the like (taken as a second shield layer) of a layer or a filter or the like having a stripe pattern along different direction to the stripe along the second direction of the first shielding layer is provided in consideration of an interaction with the first shielding layer. By the action from combining these two layers (first and second shielding layers), the predetermined function (effect) of electromagnetic-wave shielding or shielding can be achieved.

The shape of the second shielding layer is, for example, stripes along the first direction substantially orthogonal to the stripes along the second direction of the first shielding layer. The second shielding layer is formed having a pattern of metal wires extending along the first direction on, for example, a transparent film. By superposing these two layers, a grid-shape (mesh-shape) pattern is formed. As a result, a predetermined function of the mesh can be obtained. Further, since it is a superposition of the striped-shapes along the first and the second directions, the occurrence of a moiré pattern on the display surface of the panel can be prevented. With respect to the prevention of a moiré pattern, an arrangement angle of the first shielding layer with the second shielding layer may be an angle substantially orthogonal or an angle at a certain level or more, so that there is no need for fine adjustment.

A function of the second shielding layer itself assumes a partial electromagnetic-wave shielding function or a predetermined function as a light-shielding body not restricted to the electromagnetic-wave shielding function, for example, a microlouver film and the like. When the second shielding layer functions as the partial electromagnetic-wave shielding function depending on the striped-shape along the first direction, by the action (meshed-shape) of the combination with the first shielding layer, the electromagnetic-wave-shielding function can be achieved.

The effects obtained by typical aspects of the present invention will be briefly described below. According to the present invention, in the technique for a PDP, the providing the electromagnetic-wave shielding layer, the filter or the like on the front side of the panel for a countermeasure of electromagnetic wave can bring a reduction of cost. More particularly, this can deal with the occurrence of a moiré pattern on a display surface of a panel, thereby leading to a reduction of cost.

### BRIEF DESCRIPTIONS OF THE DRAWINGS

FIG. 1 is a diagram showing a basic schematic configuration of a PDP to apply the present invention;

FIG. 2 is a diagram showing basics of field drive control to the PDP of the present invention;

FIG. 3 is a diagram showing a partial structure (corresponding to a display cell) of a lateral cross-section (x-z plane) in the PDP according to an embodiment of the present invention;

FIG. 4 is a diagram showing a partial schematic structure of a part of a plane viewed from the front side in the PDP according to the embodiment of the present invention;

FIG. 5A is a diagram showing a schematic structure of a cell pattern on a display surface of a panel in the PDP according to the embodiment of the present invention;

FIG. 5B is a diagram showing schematic structures of an electromagnetic-wave shielding layer of a film filter in the PDP according to the embodiment of the present invention;

FIG. 6A is a diagram showing an example of a superposition structure of the cell pattern and the electromagnetic-wave shielding layer where there is a slight shift in the arrangement angle in the PDP according to the embodiment of the present invention;

FIG. 6B is a diagram showing an example of the superposition structure of the cell pattern and the electromagnetic-wave shielding layer where there is an angle of a certain degrees or more in the arrangement angle in the PDP according to one embodiment of the present invention;

FIG. 7A is a diagram showing a schematic structure of a cell pattern on the display surface of the panel in a PDP of an example of a conventional art;

FIG. 7B is a diagram showing a schematic structures of a mesh shielding layer in the PDP of the example of the conventional art;

FIG. 8A is a diagram showing an example of the superposing structure of the cell pattern and the mesh shielding layer where there is a slight shift in the arrangement angle in the PDP of the example of the conventional art; and

FIG. 8B is a diagram showing an example of the superposing structure of the cell pattern and the mesh shielding layer where there is an angle of certain degrees or more in the arrangement angle in the PDP of the example of the conventional art.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

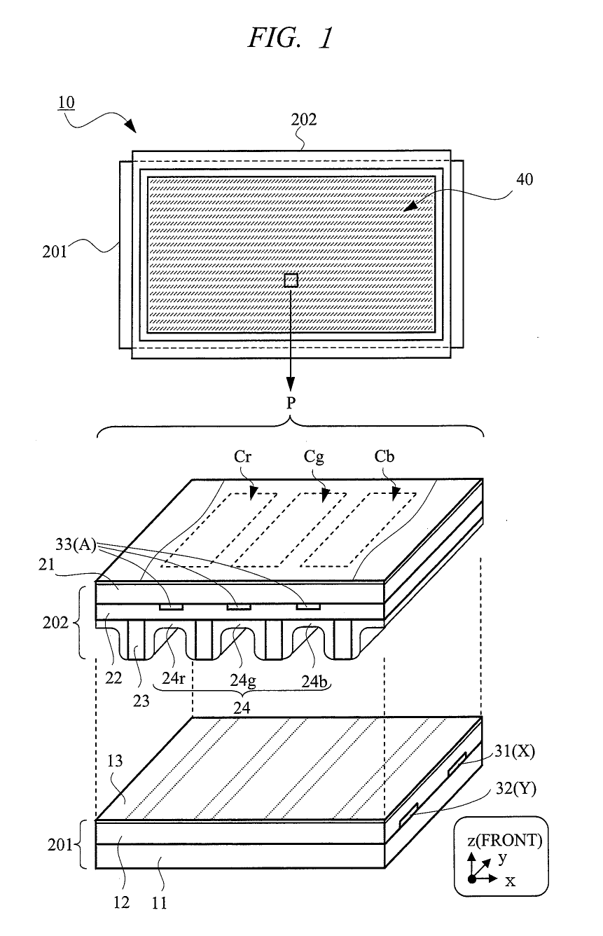

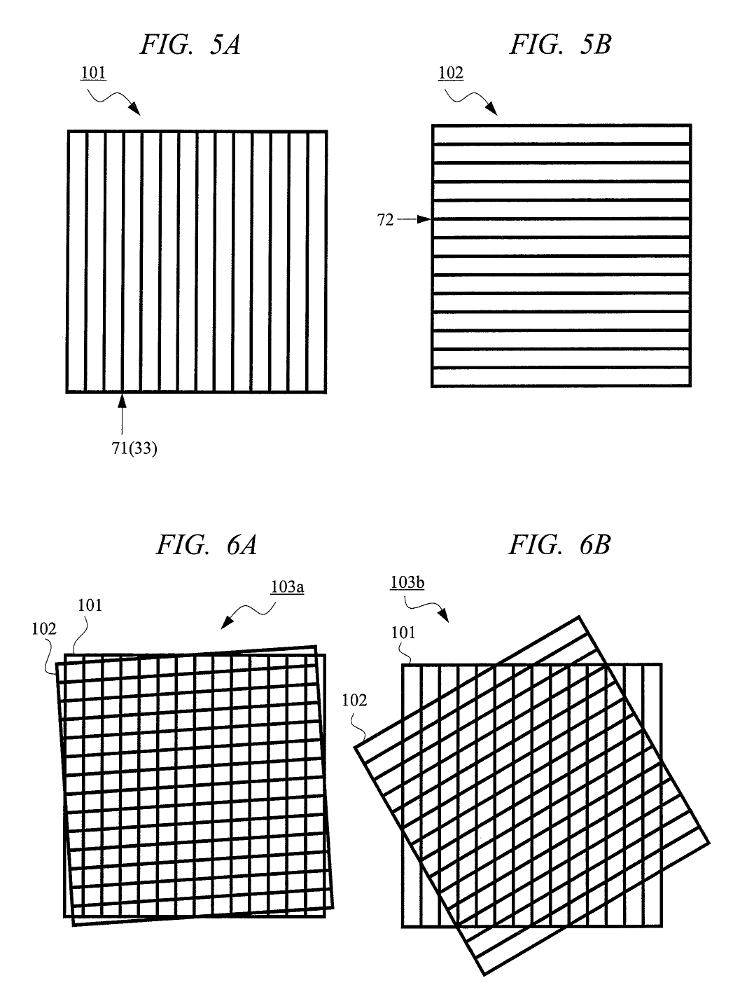

With reference to FIG. 1 to FIG. 6, a PDP 10 according to an embodiment of the present invention will be described. In the PDP 10 of the present embodiment, as features thereof, according to a predetermined configuration of a transmission-type PDP, a mesh electromagnetic-wave shielding layer (function) is configured by superposing a layer formed of longitudinally (y) striped address electrodes 33 (first shielding layer 101) of a front unit 202 and a laterally (x) striped electromagnetic-wave shielding layer (second shielding layer 102) in a film filter 60 on the front surface of a panel (see FIG. 5 and FIG. 6 and others).

<Basic Configuration>

First, in FIG. 1, the PDP 10 serving as a basic structure will be described, and the detailed features thereof will be described later. The PDP 10 of FIG. 1 is a case of an AC-type/surface-discharge and three-electrode (X, Y, A) configuration based on the transmission-type PDP. For purposes of illustration, the PDP 10 has a first direction (x), a second direction (y), and a third direction (z). For a display area (screen) 40 of the PDP 10, the reference symbol x denotes a direction of a horizontally extending display row, the reference symbol y denotes a direction of a vertically extending display column, and the reference symbol z denotes a front-rear direction perpendicular to the panel surface, and the upper side is the front surface (display surface) side, and the lower side is the rear surface side.

The PDP 10 mainly comprises a first substrate structure (rear unit) 201 and a second substrate structure (front unit) 202, which are a substrate structure pair of the front surface side and the rear surface side sandwiching discharge spaces. The display area 40 of the PDP 10 is made of columns of display cells (C). A set of the display cells (Cr, Cg, Cb) corresponding to each color of R (red), G (green), B (blue) in the first direction (x) forms a pixel (P).

The rear unit 201 includes a first glass substrate (rear glass substrate) 11, display electrodes (31, 32), a first dielectric layer 12, and a protective layer 13. A plurality of display electrodes (31, 32) are formed on the first glass substrate 11 (front side) extending in parallel in the first direction (x). The first dielectric layer 12 is formed on the first glass substrate 11 so as to cover the display electrodes (31, 32). Further, the protective layer 13 is formed on the side of a surface exposed in the discharge space on the first dielectric layer 12. The display electrodes (31, 32) comprise a sustain electrode (X) 31 for sustain drive and a scanning electrode (Y) 32 for sustain and scanning drive.

The front unit 202 includes a second glass substrate (front glass substrate) 21, an address electrode (A) 33, a second dielectric layer 22, a stripe barrier rib 23, and phosphor layers 24 {24r, 24g, 24b}. A plurality of address electrodes 33 are formed on the second glass substrate 21 (rear side) extending in parallel in the second direction (y) so as to cross the display electrodes (31, 32). The second dielectric layer 22 is formed so as to cover the address electrode 33 on the second glass substrate 21. The address electrode 33 is aimed for a select drive of displaying (on/off) the display cells (C).

Further, in the present PDP 10, barrier ribs 23, phosphor layers 24, and the like are formed to the front unit 202 side. The barrier ribs 23 are formed in stripes extending along the second direction (y) on the second dielectric layer 22 and between the address electrodes 33. As a structure of the barrier rib 23, other than the striped-shape of the present example, there a box-shape (a structure where the discharge space (S) is comparted per a display cell (C)) and so forth. The phosphor layers 24 {24r, 24g, 24b} of respective colors of R, G, B are, between the barrier ribs 23, formed on the surface of the second dielectric layer 22 corresponding to the address electrode 33 and on the side surfaces of the barrier rib 23.

The front unit 202 and the rear unit 201 are arranged so as to face each other, and a peripheral part of the substrate thereof are sealed by a seal glass and the like, and a discharge gas, for example, Ne—Xe gas is filled and encapsulated in the space comparted by the barrier ribs 23, thereby forming the PDP 10. In the PDP 10 of the above structure, when an electric field is applied between the electrodes by a drive from the circuit unit side of the PDP, the discharge gas is excited and ionized, so that vacuum ultraviolet ray is emitted. This emitted vacuum ultraviolet ray hits upon the phosphor layer 24, whereby the corresponding color of the visible light is emitted from the phosphor layer 24. This visible light is utilized for display luminance at the display cell (C). As the discharge between electrodes, for example, the sustain discharge between the sustain electrode (X) 31 and the scanning electrode (Y) 32, and an address discharge between the scanning electrode (Y) 32 and the address electrode (A) 33 and the like are performed.

Although not illustrated, other than the above-described PDP 10, a PDP module includes a driving circuit for driving an electrode group of the PDP 10 by applying a voltage, a control circuit for controlling the entirety including the driving circuit, and a circuit unit such as a power supply circuit. From the circuit unit, an image display to the PDP 10 is performed by the known drive control of the field and subfield. The rear side of the PDP 10 is fixed to a chassis, and the rear side of the chassis has mounting regions for the circuit unit and the like. The PDP module is accommodated into an external chassis, thereby forming a PDP device (set).

<Drive Control>

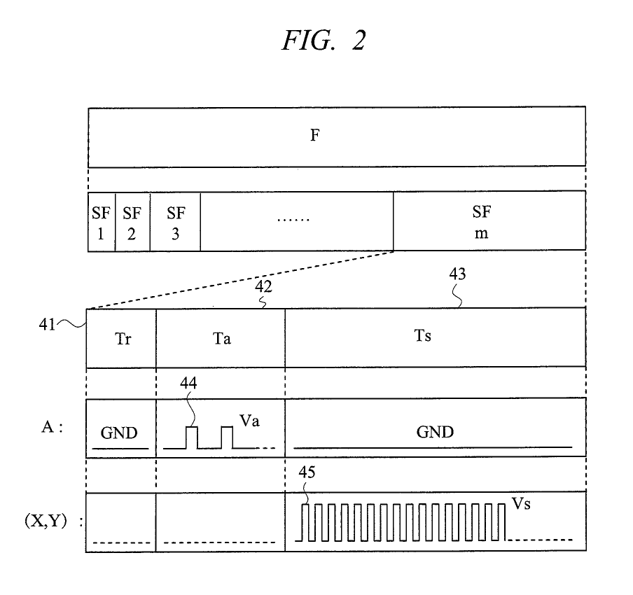

FIG. 2 shows a field drive control for the PDP 10 by the circuit unit. A display region 40 and one field (F) corresponding to a predetermined period are formed by a plurality of subfields (SF1 to SFm) divided in terms of time period for grayscale expression. Each subfield is, for example, configured by a reset period (Tr) 41, an address period (Ta) 42, and a sustain period (Ts) 43.

In the drive control of the present embodiment, to an address electrode (A) 33, an addressing is performed by an application of an address pulse 44 (voltage: Va) corresponding to the selection of an On display cell in the address period (Ta) 42. The Va is, for example, 65V. In the reset period (Tr) 41 and the sustain period (Ts) 43, the address electrode (A) 33 is sustained at the ground (GND). To the sustain electrode (X) 31 and the scanning electrode (Y) 32, an operation by an application of a predetermined waveform according to the drive system is performed in the rest period (Tr) 41 and the address period (Ta) 42. In the sustain period (Ta) 43, for light emission by sustain discharge, a sustain operation by a repeated application of a sustain pulse 45 (voltage: Vs) of high voltage and high frequency is performed. The voltage Vs is, for example, 200V, and is larger than Va.

The potential of the address electrode 33 is fixed constant (for example, ground potential) in the sustain period (Ts) 43, so that the occurrence of the electromagnetic wave in the sustain period (Ts) 43 which occupies a large ratio in the all driving period is prevented.

<Cross Section>

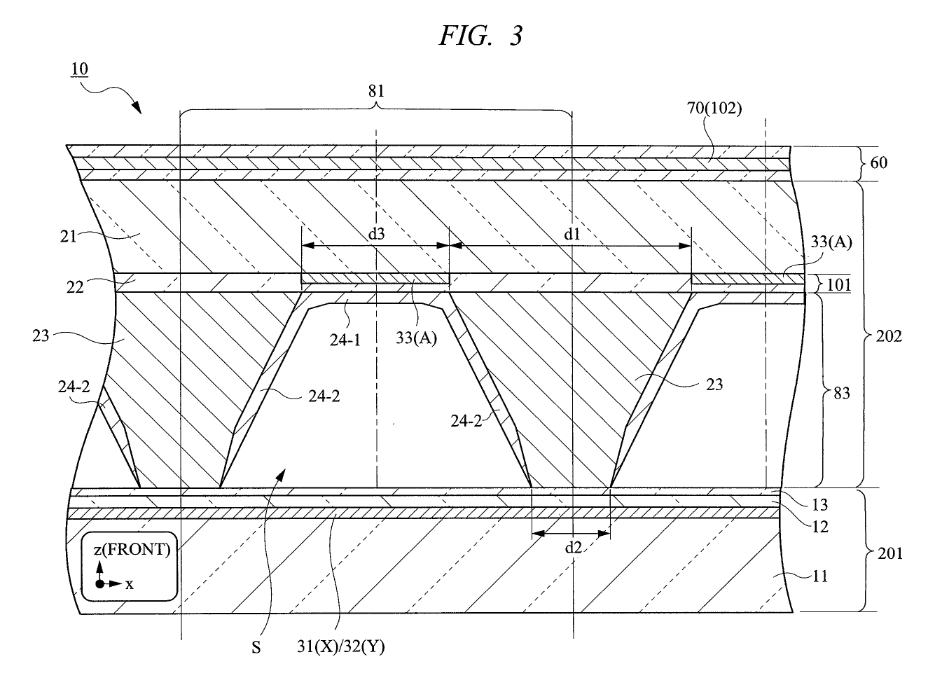

Next, FIG. 3 shows a cross sectional structure (cross section cut along the line x-z) of the PDP 10 of the present embodiment. In FIG. 3, a cross section at a unit emission region 81 corresponding to a single display cell (C) is shown. Further, cross sections of display electrodes (31, 32) (for example, the bus electrode thereof) an electromagnetic-wave shielding layer 70 (second shielding layer 102) cut along a metal straight line 72 are shown. The unit emission region 81 is an emission region in the center of the address electrode 33. An inter-substrate region (discharge space region) 83 is a region such as a discharge space (S) and the barrier rib 23 between the front unit 202 and the rear unit 201 (i.e., between substrates). The thicknesses of the first glass substrate 11 and the second glass substrate 21 are practically larger than the inter-substrate region 83.

The address electrode 33 and the second dielectric layer 22 are formed to the rear surface of the second glass substrate 21 of the front unit 202. The display electrodes (31, 32), a first dielectric layer 12, and a protective layer 13 are formed to the front surface of the first glass substrate 11 of the rear unit 201. The barrier rib 23 having a striped structure along the longitudinal direction (y) is formed to the front unit 202 by, for example, sandblast and the like. Between the barrier ribs 23, the phosphor layer 24 is formed by coating and the like. The phosphor layer 24 includes a bottom surface portion 24-1, and a side surface portion 24-2. The bottom surface portion 24-1 is formed on a surface of the second dielectric layer 22 corresponding to the address electrode 33 of the front unit 202 side. The side unit 24-2 is formed on the side surface of the barrier rib 23.

The layer by the address electrode 33 (it may be considered to include the second dielectric layer 22) is the longitudinally (y) striped metal pattern layer (first shielding layer 101) (corresponding to FIG. 5A).

To increase emission efficiency as the transmission-type PDP, the barrier rib 23 is made translucent to the discharge emission. That is, light diffusion property is added to optical transmittance in some degree, thereby improving the light guiding efficiency in the front direction (specifically, by filling a filler such as aluminum, or titania). And, the thickness of the phosphor layer 24 is preferable to be designed so as to have predetermined transmittance. Further, for example, the pair of the display electrodes (31, 32) is preferable to have visible-light reflectivity on the front side. The discharge emission, that is, the emission (visible light) from the phosphor layer 24 by the sustain discharge of the display cell (C) is transmitted by the barrier rib 23, the second glass substrate 21, and the like so as to pass through the front surface side, and contributes as the display luminance at the unit emission region 81.

The barrier rib 23 has an substantially trapezoidal cross section, and the larger width (length of the lower side) of the bottom face of the front unit 202 side is taken as d1, and the smaller width (length of the upper side) of the bottom face of the rear unit 201 side is taken as d2. The width of the bottom unit 24-1 of the phosphor 24 between the barrier ribs 23 and the width of the address electrode 33 (length in the x direction) are taken as d3.

A film filter 60 is adhered to the front most of the front unit 202, that is, the front surface of the second glass substrate 21. The film filter 60 includes the electromagnetic-wave shielding layer 70 as a partial layer. The electromagnetic-wave shielding layer 70 has a characteristic laterally (x) striped metal pattern layer (corresponding to FIG. 5B). The layers other than the electromagnetic-wave shielding layer 70 in the film filter 60 are the adhesive layer between the second glass substrate 21 and layers having other functions/characteristics (color adjustment and the like) and the like. Further, the electromagnetic-wave shielding layer 70 may not be a partial layer and may be superposed on the front and the rear of the predetermined filter.

<Planer Surface>

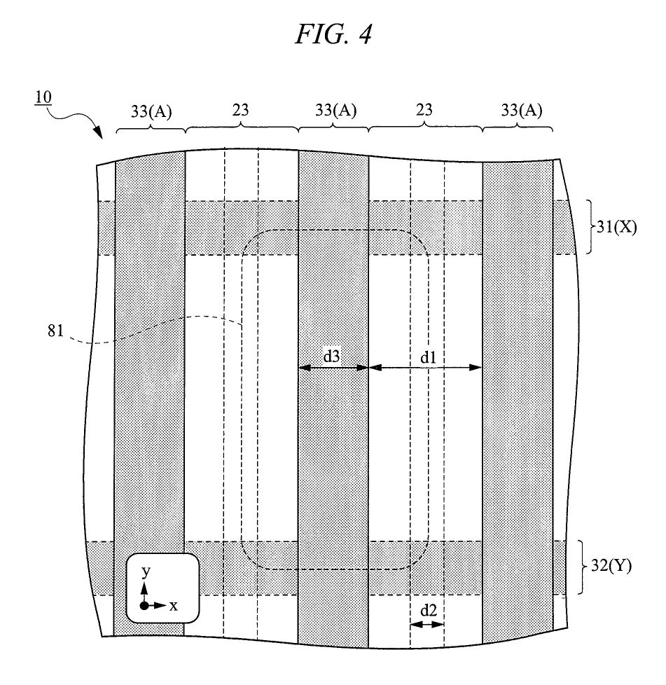

FIG. 4 shows a planar structure of the display surface on the front unit 202 side corresponding to FIG. 3. The figure shows a schematic arrangement configuration of each electrode (31, 32, and 33), the barrier rib 23, and the like corresponding to the unit emission region 81. The address electrode 33 formed on the front unit 202 side of the panel is, for example, linear, and made of a metal. As the address electrode 33, for example, a black silver electrode is used. Although the pair of the display electrodes (31, 32) formed at the rear unit 201 side is shown only by straight bus electrodes made of a metal to make the description easy, a transparent electrode and an auxiliary electrode of various types may be further provided. The barrier rib 23 becomes a translucent region described above. When viewed in the unit emission region 81, the emission (for example, visible light of R) of the display cell (C) comes out in the display surface side through the region of each barrier rib 23 at both sides of the address electrode 33. The segment of the group of the address electrodes 33 corresponds to the metal straight lines 71 in the longitudinally-striped first shielding layer 101 (FIG. 5A). The display electrodes (31, 32) on the first glass substrate 11 are almost unrecognizable from the display surface since the barrier rib 23 is translucent. Therefore, these display electrodes do not affect the moiré.

<Electromagnetic-wave Shielding>

Next, FIG. 5 and FIG. 6 show characteristic configurations and effects of the PDP 10 according to the present embodiment. FIG. 5A shows a cell pattern (first shielding layer 101) on the panel display surface (display region 40). This cell pattern (first shielding layer 101) has a structure which looks like schematically longitudinally (y) striped (pattern, design, and the like) because of the address electrode 33 (metal straight line 71), the barrier rib 23, and the like. FIG. 5B shows a pattern (second shielding layer 102) of the electromagnetic-wave shielding layer 70 of the film filter 60 on the panel front surface. The present pattern (second shielding layer 102) shows a laterally (x) striped structure because of the metal straight line (electrode) 72 on the transparent film surface. The pattern of the metal straight line (electrode) 72 is, for example, fabricated by methods such as photolithography and etching or printing of a thin copper film on a PET film.

And, FIG. 6A shows a case where a superposed pattern 103a of the cell pattern (first shielding layer 101) on the panel display surface with the pattern (second shielding layer 102) of the electromagnetic-wave shielding layer 70 has a slight shift in the arrangement angle between both of the straight lines. Further, FIG. 6B shows a case as a similarly superposed pattern 103b where the arrangement angle is increased to certain degrees between both of the straight lines. Since these patterns are made of the stripes mutually superposed in different directions, the conventionally occurred moiré pattern does not occur, and the display quality can be secured. In addition, the arrangement angles of both shielding layers (101 and 102) are acceptable in a wide range including the cases of FIGS. 6A and 6B and the like because it is not necessary to consider the occurrence of a moiré pattern, and thus there is no necessity to make a fine adjustment and the like.

<Micro Louver Film>

As another configurational example, for example, in replace of the electromagnetic-wave shielding layer 70, a microlouver film and the like for controlling the direction of the transmitted light to be constant may be provided as a laterally (x) striped pattern layer having the same shape as the electromagnetic-wave shielding layer 70 at the position of the second shielding layer 102. Also in this case, the superposing of the first shielding layer 101 with the second shielding layer 102 (microlouver film) can prevent the occurrence of a moiré pattern.

<Example of Conventional Art>

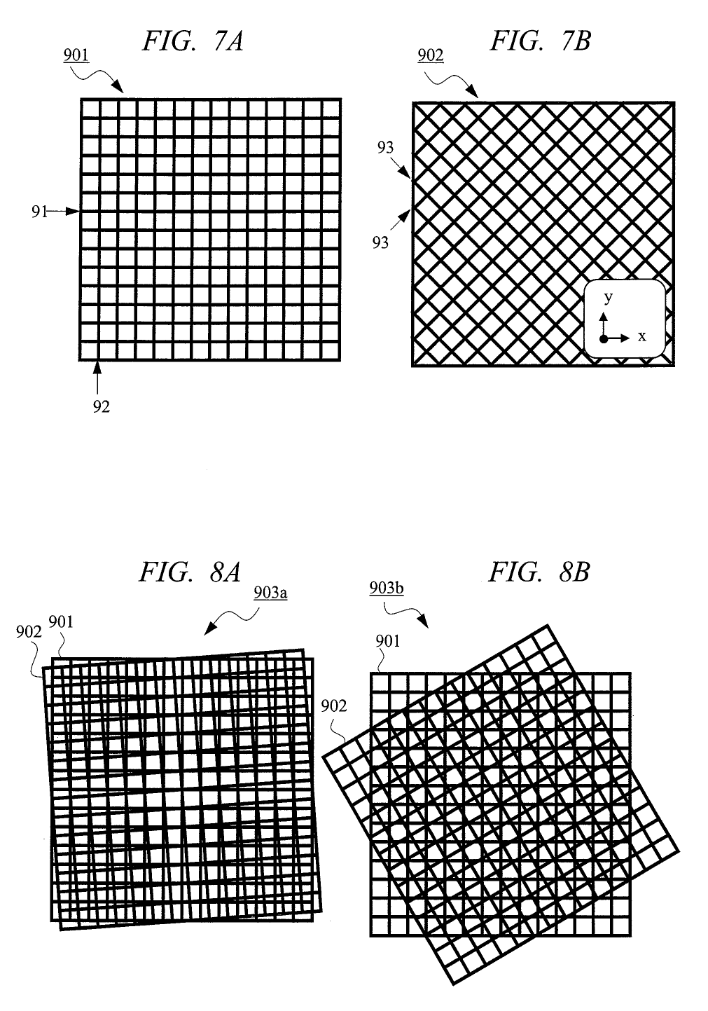

In FIG. 7 and FIG. 8, an example of conventional art will be described for the purpose of comparison with the configurations and the effects of the present embodiment. In the conventional mainstream reflection-type PDP, electromagnetic wave is generated by potential variations at a pair of display electrodes (X, Y) of the front side. Since the electromagnetic wave affects other equipments and the like, as a countermeasure to this, the electromagnetic-wave shielding is required. In the filter and the like on the front side of the panel, for a countermeasure against the electromagnetic wave emitted from the panel itself (front side), ordinarily it has been necessary to provide an electromagnetic-wave shielding layer as a partial layer of the filter. The potential variations are due to the PDP driven at high voltage (Vs) and high frequency by the driving waveform (sustain pulse) and the like in a display period of the subfield.

FIG. 7A shows an outline of a cell pattern 901 on the display surface of the conventional PDP (reflection-type PDP). The cell pattern 901 has a structure which schematically looks like a lattice made by straight lines 91 of lateral (x) display electrodes (X, Y) and the like formed on the front side of the panel and the straight lines 92 of longitudinal (y) barrier ribs and the like. For easy description, the cell pattern 901 is shown by a square lattice, but even when it is replaced by a longitudinal display cell (C) or a pixel (P) formed by a set of cells of various colors, it remains the same.

FIG. 7B shows the outline of a mesh shielding layer 902 of the filter arranged on the front side of the PDP of FIG. 7A. The mesh shielding layer 902 is a meshed pattern layer by metal straight lines (electrode) 93. The mesh shielding layer 902 is, for example, a meshed pattern formed by a copper thin film and the like as the metal straight lines 93 to a transparent film (PET film). This has relatively high electromagnetic wave shielding capability, but additionally requires to comprise a near-infrared-ray cut function. For example, a thickness of the copper thin film is 10 μm, a line width is 15 μm, and a pitch is 300 μm square. In the case of a sputtered multi-layer film, for example, it has the near-infrared-ray cut function, and has relatively low capability of the electromagnetic wave shielding.

Note that, the mesh of the mesh shielding layer 902 is illustrated as a lattice shape similarly to the cell pattern 901 (the size is also the same in the present embodiment). The figure shows a case where the arrangement angle of the straight lines of both sides is more than certain degrees (45 degrees in the present embodiment) to each other. That is, this is a structure where the metal straight line 93 is formed at a predetermined angle (45 degrees) to the plane of the external shape (rectangle) of the mesh shielding layer 902 in advance. This mode of the structure has the same effect even when the pattern layer (layer formed with no angle given to the plane of the rectangle) of the structure same as the cell pattern 901 is arranged with a predetermined angle of more than certain degrees to the cell pattern 901.

FIG. 8A shows a case where the superposing pattern 903a of the cell pattern 901 and the mesh shielding layer 902 having some shift in the arrangement angle of the straight lines of both sides to each other is shown. As shown, a moiré pattern occurs, and thus it lowers the display quality. When the electrode (metal straight line 93) of the mesh shielding layer 902 is made thick, the moiré pattern tends to be remarkable. FIG. 8B similarly shows a case where the superposing pattern 903b of both the cell pattern 901 and the mesh shielding layer 902 has an arrangement angle more than certain degrees between the straight lines of both sides. For the purpose of dealing with the moiré pattern, for example, as shown in FIG. 8B, the man hour by the worker upon manufacturing the PDP is required for making a fine adjustment such that the arrangement angle of the cell pattern 901 and the mesh shielding layer 902 becomes appropriate. Alternatively, it is necessary to design and manufacture a different mesh shielding layer 902 for every panel structure (difference in cell pattern) so that both sides are set at a predetermined arrangement angle. For example, for the adjustment of mesh angle, a novel mask (for photolithography) is required.

Note that, for example, even in a case where a conventional striped contrast-enhancement film (microlouver film) is superposed on the lattice-shaped cell pattern 901 of the display surface of the conventional reflection type PDP, a moiré pattern occurs.

On the other hand, in the present embodiment, as described above, since the front unit 202 side of the panel comprises the longitudinal (y) address electrode 33 except the display electrodes (31, 32), the moiré pattern as in FIG. 8A and 8B does not occur, thereby securing the display quality. Further, according to the present structure, the second shielding layer 102 can be simplified as compared with the structure of the meshed electrodes (metal straight lines) of the conventional mesh shielding layer (902). Furthermore, since there is a high degree of freedom in superposing, the second shielding layer 102 can be diverted to and shared by various types of the panel structures. Moreover, since there is no necessity to modify the second shielding layer 102 to a relatively complicated meshed shape, the width of the electrode (metal straight line 72) may be relatively enlarged, and by that much, the formation of electrodes upon manufacturing can be made easy (for example, as the manufacturing method, fabrication by printing is possible). In this manner, in addition to the effect of electromagnetic-wave shielding and the effect of suppression/prevention of a moiré pattern, the cost relative to manufacturing of the electromagnetic-wave shielding layer 70, the film filter 60, and the PDP 10 can be reduced.

<Others>

In addition, conventionally, to electrically connect the electromagnetic-wave shielding layer (its electrode) to the external housing, it has been necessary to form an electrode contact portion (portion exposed not superposing with other layers) contacting with the external chassis on the outer peripheral portion of the filter on the front side of the panel. On the other hand, in the present embodiment, when the structure is made so that the electromagnetic-wave shielding layer 70 is not provided to the conventional mesh shielding layer 902 or the film filter 60, the electrical connection is not required between the filter (electromagnetic-wave shielding layer) and the external chassis, and as a result, there is no necessity to provide the conventional electric contact portion, thereby leading to a lower cost.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention is applicable to a PDP device, an optical filter, and the like.

What is claimed is:

1. A plasma display panel comprising a first and a second substrate structures sandwiching a discharge space for encapsulating a discharge gas, in which a cell group is configured by an electrode group, thereby displaying a screen image on a region of the cell group by drive control by a subfield method,
wherein the first substrate structure includes a display electrode pair extending in a first direction to a first glass substrate,
wherein the second substrate structure includes an address electrode extending in a second direction to a second glass substrate,
wherein the first substrate structure is arranged on a rear surface side, and the second substrate structure is arranged on a front surface side,
wherein the second substrate structure includes barrier ribs formed by extending at least in the second direction so as to divide the discharge space and phosphor layers of respective colors formed between the barrier ribs and exposed in the discharge space,
wherein the barrier rib is translucent to the light emission from the phosphor,
wherein, during a display period for performing a sustain discharge at the display electrode pair in the subfield is performed by the drive control, an electric potential of the address electrode is substantially held constant, and
wherein, to the front surface side of the second substrate structure, a second shielding layer or a light-shielding body of a stripe pattern is provided along a direction different to the first shielding layer of the address electrode group in stripes along the second direction.

2. The plasma display panel according to claim 1,
wherein a film filter is attached to the front surface of the second glass substrate, and the second shielding layer is included as a part-layer of the film filter.

3. The plasma display panel according to claim 1,
wherein the second shielding layer is an electromagnetic-wave shielding layer.

4. The plasma display panel according to claim 1,
wherein the light-shielding body is a microlouver film.

5. The plasma display panel according to claim 1,
wherein the stripe pattern along the first direction of the second shielding layer is formed of metal lines formed on a transparent film.

6. The plasma display panel according to claim 1,
wherein the stripe pattern of the second shielding layer or the light-shielding body is arranged so as to be substantially orthogonal to the stripe pattern in the second direction of the first shielding layer.
